(19) United States
(12) Patent Application Publication
(10) Pub. No.: US 2003/0129017 A1
(43) Pub. Date: Jul. 10, 2003

(54) Display binder with removable support clip

(76) Inventor: Rick Morris, San Diego, CA (US)

Correspondence Address: John R. Ross, III, Ross Patent Law Office, P.O. Box 2138, Del Mar, CA, 92014, US

(21) Appl. No.: 10/040,875

(22) Filed: Jan. 5, 2002

(51) Int. Cl. B42F 13/00

(52) U.S. Cl. 402/73

(57) ABSTRACT

A display binder having a spine, a first cover connected to the spine, and a second cover also connected to the spine. A support clip is removably attached to the first cover and the second cover. In a preferred embodiment, the support clip has a first ear and a second ear. The ears function to provide a compressive force to the first cover and second cover, thereby attaching the support clip to the first and second covers. Also, in the preferred embodiment, the support clip is attached to the first and second covers along their bottom edges.

### BACKGROUND OF THE INVENTION

Books and notebooks have been known in the prior art for several hundred years. More specifically, a book is a set of written, printed, or blank pages fastened along one side and encased between protective covers. A notebook is a book with blank pages normally used for recording notes or memoranda. Notebooks and books may be permanently bound or their pages may be contained within a binder that allows for the addition or removal of paper. For example, a loose-leaf binder is a type of a binder that has a backbone and page holders that may be opened for adding, arranging, or removing pages. The ring binder is a loose-leaf binder in which split metal rings attached to a metal back hold perforated sheets of paper. Ring binders are used extensively in the education system from the earliest of grade levels through graduate school. They are found in abundance in classrooms throughout the world. Ring binders are most often used to contain paper pages of a particular subject matter, but they are sometimes used to display information.

Although notebooks and books are commonly used to store paper as described above, if their protective covers are sufficiently rigid and if they are properly supported they can also function to a display information, such as presenting photographs, signs, posters, lesson plans and other information. In this use, a binder, book or notebook is sometimes referred to as a display easel or a display binder. Currently, however, teachers find it difficult to properly support the binders in a convenient, acceptable fashion.

What is needed is a better way to support display binders.

### SUMMARY OF THE INVENTION

The present invention provides a display binder having a spine, a first cover connected to the spine, and a second cover also connected to the spine. A support clip is removably attached to the first cover and the second cover. In a preferred embodiment, the support clip has a first ear and a second ear. The ears function to provide a compressive force to the first cover and second cover, thereby attaching the support clip to the first and second covers. Also, in the preferred embodiment, the support clip is attached to the first and second covers along their bottom edges.

### BRIEF DESCRIPTION OF THE DRAWINGS

FIG. 1 shows a perspective view of a first preferred embodiment of the present invention.

FIG. 2 shows a side exploded view of the first preferred embodiment.

FIG. 3 shows a side view of the first preferred embodiment.

FIG. 4 shows a side view of the second preferred embodiment of the present invention.

FIG. 5 shows a preferred support clip of the third preferred embodiment of the present invention.

FIG. 6 shows a side view of the third preferred embodiment.

FIG. 7 shows stacked display binders.

FIGS. 8 and 9 show a fourth preferred embodiment of the present invention.

FIG. 10 shows a side view of a preferred support clip.

FIG. 11 shows a top view of the preferred support clip of FIG. 10.

FIG. 12 shows a fifth preferred embodiment of the present invention.

FIG. 13 shows a sixth preferred embodiment of the present invention.

FIG. 14 shows a preferred die.

FIG. 15 shows extruded PVC.

FIG. 16 shows cut lines on the extruded PVC of FIG. 15.

FIG. 17 shows a side view of a preferred support clip.

FIG. 18 shows a top view of a preferred support clip.

FIG. 19 shows a preferred embodiment of the present invention.

FIG. 20 shows a preferred embodiment of the present invention.

FIG. 21 shows a top view of preferred support clip.

FIG. 22 shows a side view of the preferred support clip of FIG. 21.

FIG. 23 shows a preferred embodiment of the present invention.

### DETAILED DESCRIPTION OF PREFERRED EMBODIMENTS

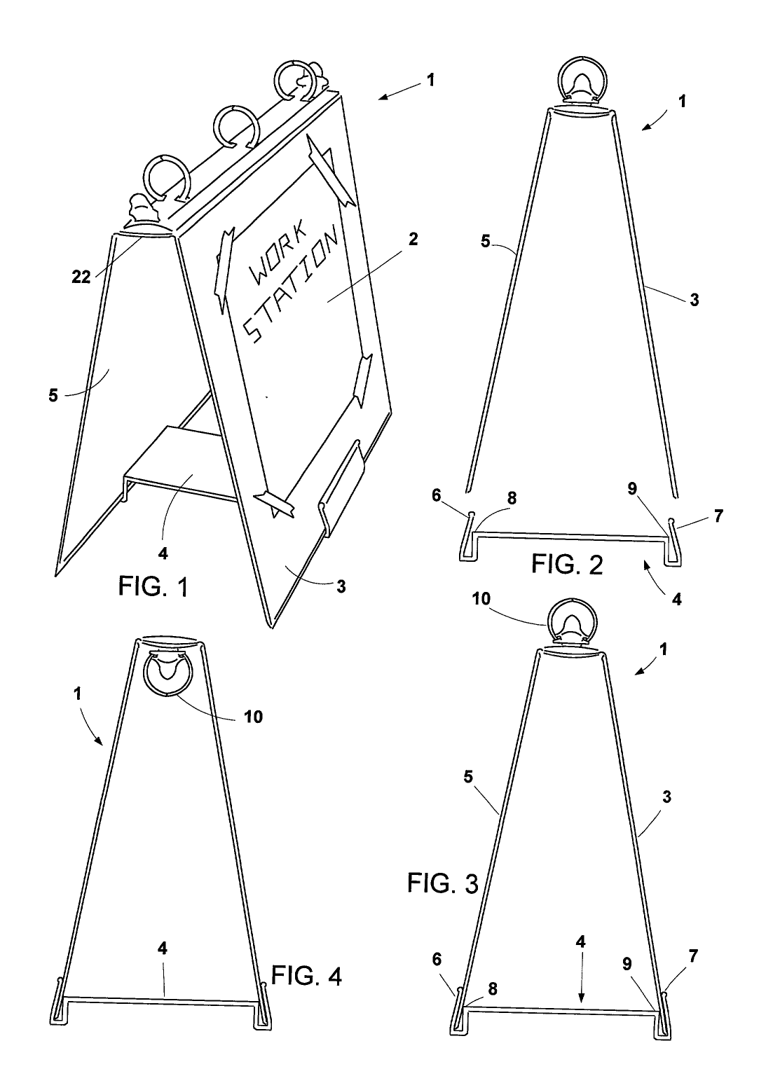

A detailed description preferred embodiments of the present invention can be seen by reference to FIGS. 1-23.

### First Preferred Embodiment

FIG. 1 shows a perspective view and FIG. 3 shows a side view of a first preferred embodiment of the present invention. In this embodiment, a standard three-ring binder having covers 3 and 5, spine 22 and three ring clips 10 is converted into a display binder with the use of novel support clip 4. Sheet 2 has been taped to rigid cover 3 and displays the message “Work Station”. Removable support clip 4 has been pressed onto the bottom edges of covers 3 and 5. While attached to covers 3 and 5, support clip 4 maintains binder 1 in a position roughly similar to that of an upside down “V”. This is a preferred position of a display binder and allows for a good display of the message “Work Station” on sheet 2. When finished utilizing binder 1 as a display binder, a user can easily pull support clip 4 away from covers 3 and 5. Support clip 4 can then later be reattached to binder 1 to once again use it as a display binder, or, similarly, it can be attached to another book or notebook to create a display binder.

### Support Clip

FIG. 2 shows a side view of binder 1 positioned over a preferred support clip 4. Support clip 4 is preferably fabricated from extruded polyvinyl chloride (PVC). Preferably, support clip 4 is approximately 0.10 inch thick, 6¼ inches long and 2 inches wide.

As explained above, support clip 4 is attached to binder 1 by pressing it onto the bottom edges of covers 3 and 5. Preferably, support clip 4 has flexible ears 6 and 7. In the preferred embodiment, flexible ear 6 is separated from corner 8 by approximately 0.07 inches. Likewise, flexible ear 7 is also separated from corner 9 by approximately 0.07 inches. Preferably, flexible covers 3 and 5 are each approximately 0.10 inches thick. Therefore, when support clip 4 is pressed onto the bottom edges of flexible covers 3 and 5, flexible ears 6 and 7 bend outward to accommodate flexible covers 3 and 5, as shown in FIG. 3. The bottom edge of flexible cover 5 is squeezed between flexible ear 6 and corner 8 and the bottom edge of flexible cover 3 is squeezed between flexible ear 7 and corner 9. In this manner, support clip 4 is attached to binder 1.

As stated above, to remove support clip 4 from binder 1 the user pulls support clip 4 away from covers 3 and 5, overcoming the compressive force exerted on the bottom edges of covers 3 and 5 by flexible ears 6 and 7.

### Method of Making Support Clip

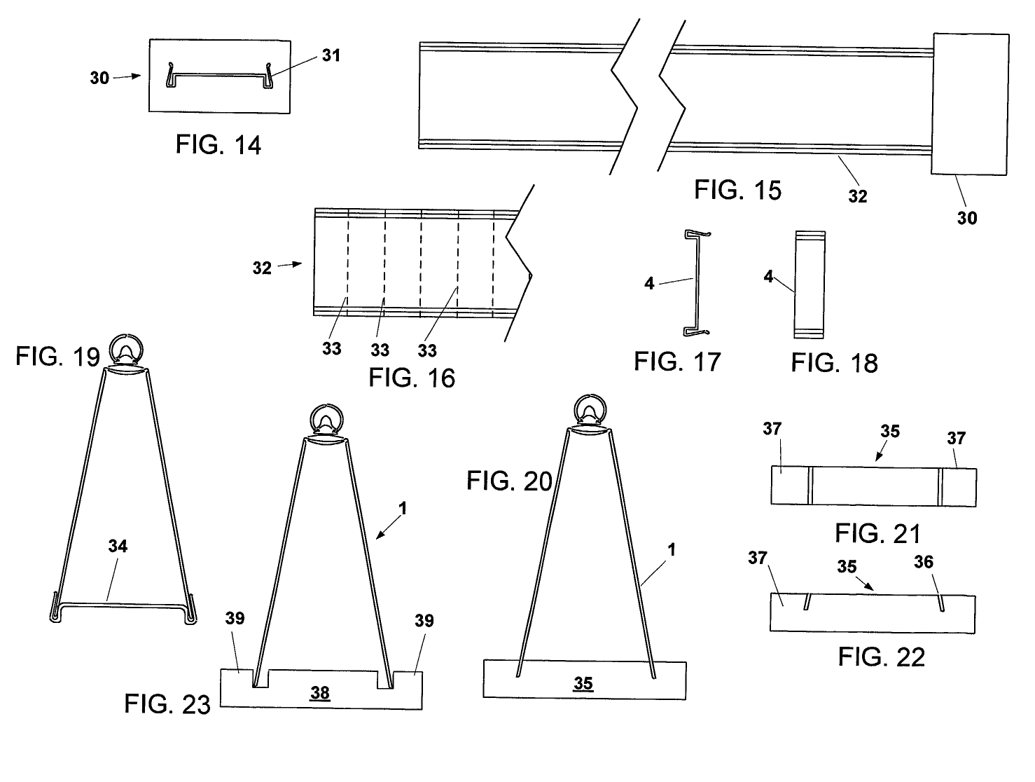

In the first preferred embodiment, support clip 4 is cut in 2 inch wide segments from extruded PVC. FIG. 14 shows a side view of die 30 with opening 31. FIG. 15 shows a top view of extruded PVC section 32 being extruded through die 30. As shown in FIG. 16, extruded PVC section 32 is cut along lines 33 with a saw blade to create support clip 4. FIG. 17 shows a side view of support clip 4 and FIG. 18 shows a top view of support clip 4.

### Second Preferred Embodiment

In the second preferred embodiment (FIG. 4), support clip 4 has been attached to binder 1 as in the first preferred embodiment. However, rings 10 are now on the inside of binder 1, as opposed to the outside, as shown in FIG. 3.

### Third Preferred Embodiment

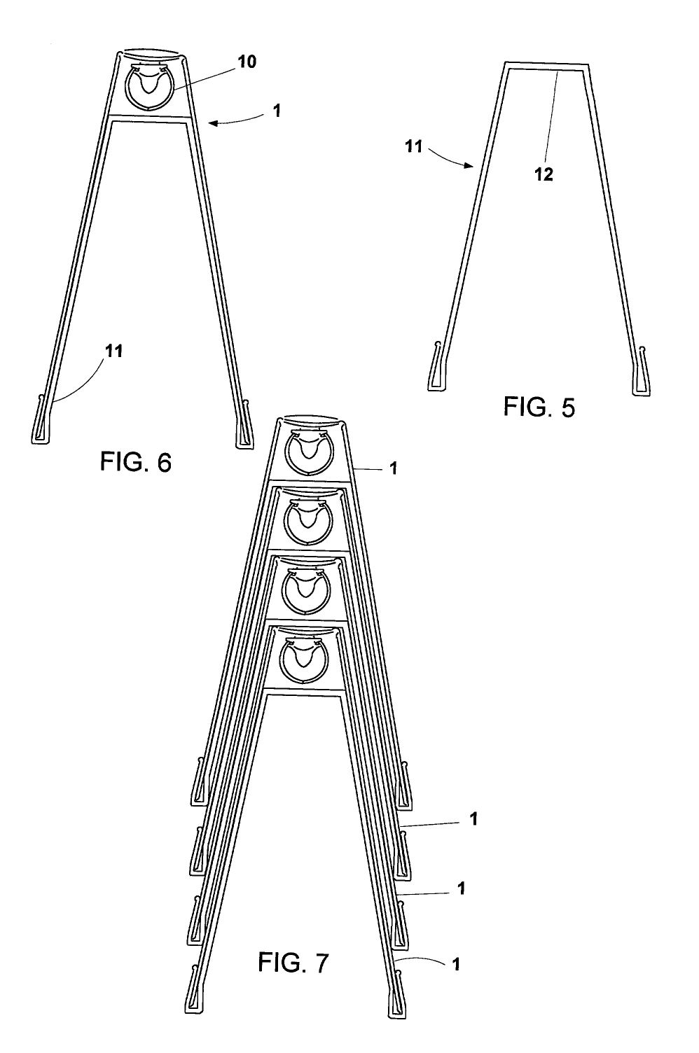

A third preferred embodiment is described by reference to FIGS. 5-7. FIG. 5 shows support clip 11. Support clip 11 has a higher apex 12 that extends up high inside binder 1 so that it comes in close contact to rings 10 (FIG. 6). The utilization of support clip 11 allows for easy stacking of binders 11, as shown in FIG. 7.

### Fourth Preferred Embodiment

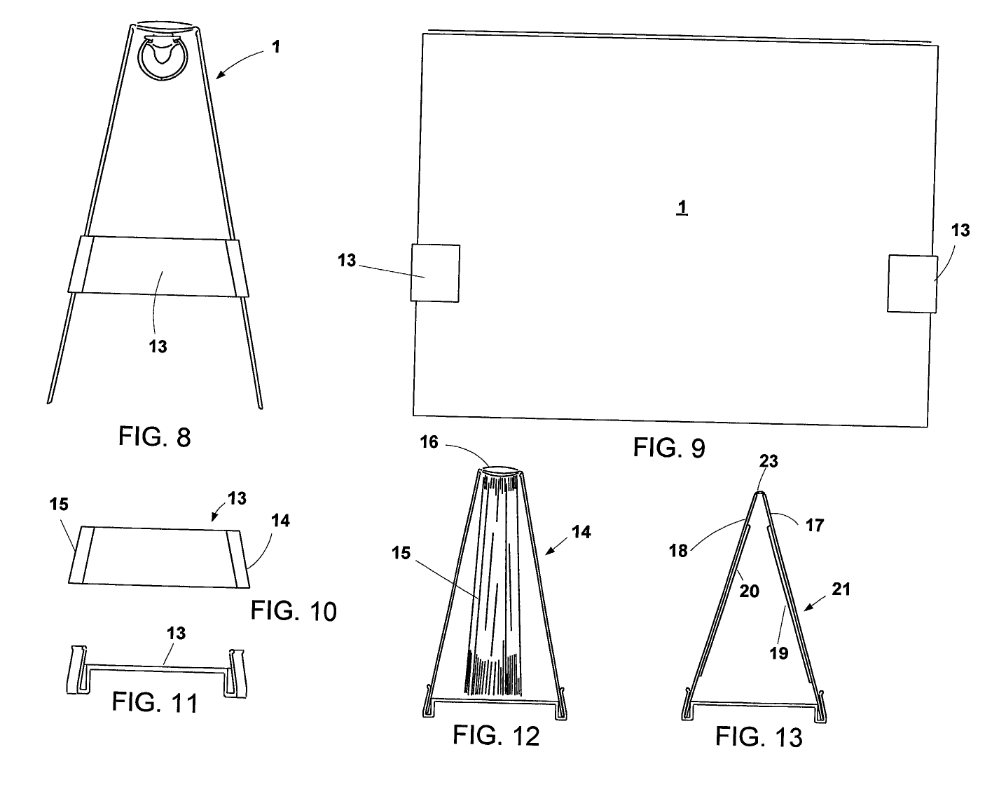

A fourth preferred embodiment is seen by reference to FIGS. 8-11. In the fourth preferred embodiment support clip 13 is attached to the side of binder 1, as shown in FIGS. 8 and 9. FIG. 10 shows a side view and FIG. 11 shows a top view of support clip 13. Edges 14 and 15 are at an angled to point inward at their top end to conform to the upside down “V” shape of binder 1. Support clip 13 is removed and attached in a fashion similar to that described above in reference to earlier preferred embodiments.

### Fifth Preferred Embodiment

A fifth preferred embodiment is shown in FIG. 12. In the fifth preferred embodiment, binder 14 is a book having pages 15 bound to side 16.

### Sixth Preferred Embodiment

A sixth preferred embodiment is shown in FIG. 13. The sixth preferred embodiment shows support clip 4 attached to the bottom edges of covers 17 and 18 of folder 21. In the sixth preferred embodiment, no pages are bound between covers 17 and 18. Because no pages are bound between covers 17 and 18, spine 23 can be made much smaller than spine 22 (FIG. 1). Folder 21 preferably has pockets 19 and 20 for storage of paper, pencils, pens, erasers, calculators, and the like.

Although the above-preferred embodiments have been described with specificity, persons skilled in this art will recognize that many changes to the specific embodiments disclosed above could be made without departing from the spirit of the invention. For example, although specific preferred dimensions and materials were discussed in regards to support clip 4, it would be possible to fabricate support clip 4 out of a variety of materials and it would be possible for support clip 4 to have a variety of dimensions. For example, in addition to PVC, support clip 4 could be fabricated from other types of materials such as plastics, composites, metals and wood. For example, FIG. 19 shows a side view of support clip 34. Support clip 34 is preferably made by bending a section of a 1/16 inch diameter coat hanger wire. Also, FIG. 20 shows binder 1 inserted into wood support clip 35. Support clip 35 has grooves 36 to receive binder 1. Sections 37 of support clip 35 are an example of a non-flexible ear. FIG. 21 shows a top view of support clip 35 and FIG. 22 shows a side view of support clip 35. Also, although it was stated that support clip 4 is preferably extruded through die 30 (FIGS. 14 and 15), support clip 4 can be made utilizing other methods. For example, in another preferred embodiment, support clip 4 is heat formed. Also, in another preferred embodiment, injection molding is used to make support clip 4. Also, support clip 4 can be made having different lengths, widths and thicknesses than was discussed above. Also, although flexible ears 6 and 7 were described as being flexible, it would also be possible to make ears 6 and 7 substantially rigid so that they do not bend when binder 1 is inserted into support clip 4. As with the flexible ears, the non-flexible ears would preferably squeeze the covers of the binder as the binder is inserted into the support clip. However, it would also be possible to have ears that do not squeeze or exert a substantial compressive force onto the covers. For example, FIG. 23 shows binder 1 inserted into support clip 38. Support clip 38 has ears 39 that do not squeeze or exert a substantial compressive force on the covers of binder 1. Therefore, the attached claims and their legal equivalents should determine the scope of the invention.

I claim:

1. A display binder, comprising:
A) a spine,
B) a first cover connected to said spine,
C) a second cover connected to said spine, and
D) at least one support clip removably attached to said first cover and said second cover.

2. The display binder as in claim 1, wherein said display binder is a loose-leaf binder.

3. The display binder as in claim 2, wherein said loose-leaf binder is a ring binder comprising a plurality of rings attached to said spine.

4. The display binder as in claim 1, wherein said display binder is a book.

5. The display binder as in claim 1, wherein said display binder is a folder.

6. The display binder as in claim 1, wherein said at least one support clip comprises a first ear and a second ear, wherein said first ear provides a compressive force to said first cover and said second ear provides a compressive force to said second cover to attach said at least one support clip to said first cover and said second cover.

7. The display binder as in claim 1, wherein said at least one support clip comprises a high apex to allow for stacking of a plurality of said display binders.

8. The display binder as in claim 1, wherein said first cover and said second cover each comprises a bottom edge, wherein said at least one support clip is removably attached to said bottom edges.

9. The display binder as in claim 1, wherein said first cover and said second cover each comprise two side edges, wherein said at least one support clip is attached to one of said side edges of said first cover and wherein said at least one support clip is attached to one of said side edges of said second cover.

10. The display binder as in claim 1, wherein said first cover and said second cover each comprise two side edges, wherein said at least one support clip is two support clips, wherein said first of said two support clips is attached to one of said side edges of said first cover and one of said side edges of said second cover, wherein said second of said two support clips is attached to the other of said side edges of said first cover and the other of said side edges of said second cover.

11. The display binder as in claim 1, wherein said at least one support clip is a side attachable support clip.

12. The display binder as in claim 11, wherein said display binder comprises a shape similar to an upside down “V”, wherein said display binder side attachable support clip further comprises:
A) a top end, and
B) two side edges pointing inward at said top end to conform to said upside down “V” shape of said display binder.

13. A display binder, comprising:
A) a spine means,
B) a first cover means connected to said spine means,
C) a second cover means connected to said spine means, and
D) at least one support clip means removably attached to said first cover means and said second cover means.

14. The display binder as in claim 13, wherein said display binder is a loose-leaf binder.

15. The display binder as in claim 14, wherein said loose-leaf binder is a ring binder comprising a plurality of rings attached to said spine means.

16. The display binder as in claim 13, wherein said display binder is a book.

17. The display binder as in claim 13, wherein said display binder is a folder.

18. The display binder as in claim 13, wherein said at least one support clip means comprises a first ear means and a second ear means, wherein said first ear means provides a compressive force to said first cover means and said second ear means provides a compressive force to said second cover means to attach said at least one support clip means to said first cover means and said second cover means.

19. The display binder as in claim 13, wherein said at least one support clip means comprises a high apex to allow for stacking of a plurality of said display binders.

20. The display binder as in claim 13, wherein said first cover means and said second cover means each comprises a bottom edge, wherein said at least one support clip means is removably attached to said bottom edges.

21. The display binder as in claim 13, wherein said first cover means and said second cover means each comprise two side edges, wherein said at least one support clip means is attached to one of said side edges of said first cover means and wherein said at least one support clip means is attached to one of said side edges of said second cover means.

22. The display binder as in claim 13, wherein said first cover means and said second cover means each comprise two side edges, wherein said at least one support clip means is two support clip means, wherein said first of said two support clip means is attached to one of said side edges of said first cover means and one of said side edges of said second cover means, wherein said second of said two support clip means is attached to the other of said side edges of said first cover means and the other of said side edges of said second cover means.

23. The display binder as in claim 13, wherein said at least one support clip means is a side attachable support clip means.

24. The display binder as in claim 23, wherein said display binder comprises a shape similar to an upside down “V”, wherein said display binder side attachable support clip means further comprises:
A) a top end, and
B) two side edges pointing inward at said top end to conform to said upside down “V” shape of said display binder.

25. A plurality of display binders, each said display binder comprising:
A) a spine,
B) a first cover connected to said spine,
C) a second cover connected to said spine, and
D) at least one support clip removably attached to said first cover and said second cover,
wherein said plurality of display binders are stacked.
